(19) United States
(12) Patent Application Publication
(10) Pub. No.: US 2024/0059007 A1
(43) Pub. Date: Feb. 22, 2024

(54) RADIATION-CURABLE LIQUID COMPOSITION AND 3D-PRINTED OBJECT FORMED FROM THE SAME

(71) Applicant: BASF SE, Ludwigshafen am Rhein (DE)

(72) Inventors: Wei Zheng FAN, Shanghai (CN); Zhi Zhong CAI, Shanghai (CN); Na LIU, Shanghai (CN)

(21) Appl. No.: 18/265,697

(22) PCT Filed: Dec. 2, 2021
(86) PCT No.: PCT/EP2021/084011

§ 371 Date: Jun. 7, 2023

(30) Foreign Application Priority Data
Dec. 16, 2020 (WO) PCT/CN2020/136776

(51) Int. Cl. B29C 64/124; B33Y 70/00; B33Y 10/00; B33Y 80/00

(52) U.S. Cl. CPC B29C 64/124; B33Y 70/00; B33Y 10/00; B33Y 80/00; B29K 2105/24

(57) ABSTRACT

This disclosure relates to a radiation-curable liquid composition, comprising following components: (A) at least one radiation-curable reactive component; (B) at least one photoinitiator; and (C) at least one expandable microsphere and/or lightweight filler, relates to a 3D-printed object formed from the radiation-curable liquid composition as well as a process of forming the 3D-printed object. The 3D-printed object formed from the composition shows excellent energy return property and good mechanical property as well as low density and foam structure.

### TECHNOLOGY FIELD

The present invention belongs to the technical field of chemical materials for three-dimensional (hereinafter referred to as “3D”) printing, and in particular relates to a radiation (such as photo)curable composition for 3D printing, its preparation process and use, and also to a method of forming a 3D-printed object by using the composition.

### BACKGROUND

3D-printing technologies using curable polymer, e.g. stereolithography (SLA), digital light processing (DLP) or photopolymer jetting (PPJ), have been used in many applications, such as rapid prototyping and rapid manufacturing processes of hearing aids or dental parts. While, it is a challenge to obtain a lightweighted 3D-printed parts due to their organic chemical component of general component. On the other hand, it is difficult to obtain printed parts with closed porous or foam structure based on the curable polymer since it's difficult for the 3D printing process to control uniform foaming and let the uncured polymer leave the printed parts. Therefore, there is a strong need to develop a new class of radiation-curable liquid composition to enable form lightweighted parts in 3D printing process by stereolithography (SLA), digital light processing (DLP) or photopolymer jetting (PPJ) etc.

### SUMMARY OF THE INVENTION

It is an object of the invention to provide a radiation-curable liquid composition comprising an expandable microsphere and/or lightweight filler, wherein the 3D-printed object formed from the composition shows excellent energy return property and low density and at the same has good mechanical property.

Another object of the present invention is to provide a 3D-printed object formed from the radiation-curable liquid composition of the present invention.

A further object of the present invention is to provide a process of forming 3D-printed object by using the radiation-curable liquid composition of the present invention.

It has been surprisingly found that the above objects can be achieved by following embodiments:

1. A radiation-curable liquid composition, comprising following components:
(A) at least one radiation-curable reactive component;
(B) at least one photoinitiator; and
(C) at least one expandable microsphere and/or lightweight filler.

2. The radiation-curable liquid composition according to item 1, wherein the reactive component (A) comprises at least one oligomer and/or monomer containing at least one ethylenically unsaturated functional group.

3. The radiation-curable liquid composition according to items 1 or 2, wherein the functionality of the reactive component (A) is in the range from 1 to 12, preferably from 1 to 8.

4. The radiation-curable liquid composition according to items 2 or 3, wherein the oligomer containing at least one ethylenically unsaturated functional group is selected from the following classes: urethane, polyether, polyester, polycarbonate, polyestercarbonate, epoxy, silicone or any combination thereof; preferably, the oligomer containing at least one ethylenically unsaturated functional group is selected from the following classes: an urethane-based oligomer, an epoxy-based oligomer, a polyester-based oligomer, a polyether-based oligomer, urethane acrylate-based oligomer, polyether urethane-based oligomer, polyester urethane-based oligomer or a silicone-based oligomer, as well as any combination thereof.

5. The radiation-curable liquid composition according to any of items 2 to 4, wherein the monomer containing at least one ethylenically unsaturated functional group is monofunctional or multifunctional; preferably the monomer is selected from the group consisting of (meth)acrylate monomer, (meth)acrylamide monomer, vinylaromatics having up to 20 carbon atoms, vinyl esters of carboxylic acids having up to 20 carbon atoms, □α,β-unsaturated carboxylic acids having 3 to 8 carbon atoms and their anhydrides, and vinyl substituted heterocycles and mixture thereof.

6. The radiation-curable liquid composition according to any of items 1 to 5, wherein the amount of the reactive component (A) is in the range from 2 to 97% by weight, preferably from 5 to 95% by weight or 15 to 95% by weight, based on the total weight of the composition.

7. The radiation-curable liquid composition according to any of items 1 to 6, wherein the amount of the photoinitiator (B) is in the range from 0.1 to 10% by weight, preferably from 0.1 to 5% by weight, based on the total weight of the composition.

8. The radiation-curable liquid composition according to any of items 1 to 7, wherein the amount of component (C) is in the range from 0.1 to 70% by weight, preferably from 1 to 60% by weight, more preferably from 2 to 50% by weight or from 2 to 40% by weight, based on the total weight of the composition.

9. The radiation-curable liquid composition according to any of items 1 to 8, wherein the composition further comprises at least one auxiliary as component (D) in an amount of 0 to 50% by weight or 5 to 40% by weight, based the total weight of the composition.

10. A process of forming 3D-printed object, comprising using the radiation-curable liquid composition according to any of items 1 to 9.

11. The process according to item 10, wherein the process comprises the steps of:
(i) forming a layer of the radiation-curable liquid composition;
(ii) applying radiation to cure at least a portion of the layer of the radiation-curable liquid composition to form a cured layer;
(iii) introducing a new layer of the radiation-curable liquid composition onto the cured layer;
(iv) applying radiation to the new layer of the radiation-curable liquid composition to form a new cured layer; and
(v) repeating steps (iii) and (iv) until the 3D object is manufactured.

12. The process according to item 11, wherein the process further comprises a step of postcuring the 3D object obtained in step (v) as a whole to form a final 3D object.

13. A 3D-printed object formed from the radiation-curable liquid composition according to any of items 1 to 9 or obtained by the process according to any of items 10 to 12.

14. The 3D-printed object according to item 13, wherein the 3D-printed objects include sole, outerwear, cloth, footwear, toy, mat, tire, hose, gloves and seals.

15. The 3D-printed object according to items 13 or 14, wherein the energy return of said 3D-printed object increased by 5 to 30%, preferably 7 to 25% comparing with a 3D-printed object formed from the otherwise identical radiation-curable liquid composition only without component (C).

The radiation-curable liquid composition according to the present invention comprises expandable microsphere and/or lightweight filler, and a lightweighted 3D-printed object can be successfully obtained from the composition without changing the dimension size of printed parts, and the 3D-printed object shows excellent elasticity (energy return) property and low density and at the same time has good mechanical property and foam structure.

### DESCRIPTION OF THE DRAWING

FIG. 1 shows morphology of cured composition of example 2b.

FIG. 2 shows the pictures of 3D-printed objects obtained by printing the composition of example 2b.

FIG. 3 shows a schematic diagram illustrating Area Under Unloading Curve and Area Under Loading Curve in Cyclic Tensile Test used in the examples.

### EMBODIMENT OF THE INVENTION

The undefined article “a”, “an”, “the” means one or more of the species designated by the term following said article.

In the context of the present disclosure, any specific values mentioned for a feature (comprising the specific values mentioned in a range as the end point) can be recombined to form a new range.

### Radiation-Curable Liquid Composition

One aspect of the present invention is directed to a radiation-curable liquid composition, comprising following components:
(A) at least one radiation-curable reactive component;
(B) at least one photoinitiator; and
(C) at least one expandable microsphere and/or lightweight filler.

### Component (A)

The radiation-curable liquid composition of the present invention comprises at least one radiation-curable reactive component (A).

According to a preferred embodiment of the invention, the functionality of the radiation-curable reactive component (A) can be in the range from 1 to 12, for example 1.2, 1.5, 1.8, 2, 2.2. 2.5, 3, 3.5, 4, 5, 6, 7, 8, 9, 10, 11, preferably 1 to 8, or 1.5 to 6, or 1.5 to 4.

In a preferred embodiment, the radiation-curable reactive component (A) comprises at least one oligomer and/or monomer containing at least one ethylenically unsaturated functional group. A person skilled in the art could understand that the ethylenically unsaturated functional group in the context of the present disclosure is a radiation-curable group.

In an embodiment of the invention, the ethylenically unsaturated functional group comprises a carbon-carbon unsaturated bond, such as those found in the following functional groups: allyl, vinyl, acrylate, methacrylate, acryloxy, methacryloxy, acrylamido, methacrylamido, acetylenyl, maleimido, and the like; preferably, the ethylenically unsaturated functional group comprises a carbon-carbon unsaturated double bond.

In a preferred embodiment of the invention, the oligomer comprises, in addition to the ethylenically unsaturated functional group, urethane groups, ether groups, ester groups, carbonate groups, and any combination thereof.

Suitable oligomer includes, for example, oligomer containing a core structure linked to the ethylenically unsaturated functional group, optionally via a linking group. The linking group can be an ether, ester, amide, urethane, carbonate, or carbonate group. In some instances, the linking group is part of the ethylenically unsaturated functional group, for instance an acryloxy or acrylamido group. The core group can be an alkyl (straight and branched chain alkyl groups), aryl (e.g. phenyl), polyether, polyester, siloxane, urethane, or other core structures and oligomers thereof. Suitable ethylenically unsaturated functional group may comprise carbon-carbon double bond such as methacrylate, acrylate, vinyl ether, allyl ether, acrylamide, methacrylamide, or a combination thereof. In some embodiments, suitable oligomer comprise mono- and/or polyfunctional acrylate, such as mono (meth)acrylate, di(meth)acrylate, tri(meth)acrylate, or higher, or combination thereof. Optionally, the oligomer may include a siloxane backbone in order to further improve cure, flexibility and/or additional properties of the radiation-curable composition for 3D printing.

In some embodiments, the oligomer containing at least one ethylenically unsaturated functional group can be selected from the following classes: urethane (i.e. an urethane-based oligomer containing ethylenically unsaturated functional group), polyether (i.e. an polyether-based oligomer containing ethylenically unsaturated functional group), polyester (i.e. an polyester-based oligomer containing ethylenically unsaturated functional group), polycarbonate (i.e. an polycarbonate-based oligomer containing ethylenically unsaturated functional group), polyestercarbonate (i.e. an polyestercarbonate-based oligomer containing ethylenically unsaturated functional group), epoxy (i.e. an epoxy-based oligomer containing ethylenically unsaturated functional group), silicone (i.e. a silicone-based oligomer containing ethylenically unsaturated functional group) or any combination thereof. Preferably, the oligomer containing at least one ethylenically unsaturated functional group can be selected from the following classes: a urethane-based oligomer, an epoxy-based oligomer, a polyester-based oligomer, a polyether-based oligomer, polyether urethane-based oligomer, polyester urethane-based oligomer or a silicone-based oligomer, as well as any combination thereof.

In a preferred embodiment of the invention, oligomer containing at least one ethylenically unsaturated functional group comprises a urethane-based oligomer comprising urethane repeating units and one, two or more ethylenically unsaturated functional groups, for example carbon-carbon unsaturated double bond such as (meth)acrylate, (meth)acrylamide, allyl and vinyl groups. Preferably, the oligomer contains at least one urethane linkage (for example, one, two or more urethane linkages) within the backbone of the oligomer molecule and at least one acrylate and/or methacrylate functional groups (for example, one, two or more acrylate and/or methacrylate functional groups) pendent to the oligomer molecule. In some embodiments, aliphatic, cycloaliphatic, or mixed aliphatic and cycloaliphatic urethane repeating units are suitable. Urethanes are typically prepared by the condensation of a diisocyanate with a diol. Aliphatic urethanes having at least two urethane moieties per repeating unit are useful. In addition, the diisocyanate and diol used to prepare the urethane comprise divalent aliphatic groups that may be the same or different.

In one embodiment, oligomer containing at least one ethylenically unsaturated functional group comprises polyester urethane-based oligomer or polyether urethane-based oligomer containing at least one ethylenically unsaturated functional group. The ethylenically unsaturated functional group can be carbon-carbon unsaturated double bond, such as acrylate, methacrylate, vinyl, allyl, acrylamide, methacrylamide etc., preferably acrylate and methacrylate. The functionality of these polyester or polyether urethane-based oligomer is 1 or greater, specifically about 2 ethylenically unsaturated functional group per oligomer molecule.

Suitable urethane-based oligomers are known in the art and may be readily synthesized by a number of different procedures. For example, a polyfunctional alcohol may be reacted with a polyisocyanate (preferably, a stoichiometric excess of polyisocyanate) to form an NCO-terminated pre-oligomer, which is thereafter reacted with a hydroxy-functional ethylenically unsaturated monomer, such as hydroxy-functional (meth)acrylate. The polyfunctional alcohol may be any compound containing two or more OH groups per molecule and may be a monomeric polyol (e.g., a glycol), a polyester polyol, a polyether polyol or the like. The urethane-based oligomer in one embodiment of the invention is an aliphatic urethane-based oligomer containing (meth)acrylate functional group.

Suitable polyether or polyester urethane-based oligomers include the reaction product of an aliphatic or aromatic polyether or polyester polyol with an aliphatic or aromatic polyisocyanate that is functionalized with a monomer containing the ethylenically unsaturated functional group, such as (meth)acrylate group. In a preferred embodiment, the polyether and polyester are aliphatic polyether and polyester, respectively. In a preferred embodiment, the polyether and polyester urethane-based oligomers are aliphatic polyether and polyester urethane-based oligomers and comprise (meth)acrylate group.

In one embodiment, the viscosity of the oligomer containing at least one ethylenically unsaturated functional group at 60° C. can be in the range from 2000 to 100000 cP, for example 3000 cP, 4000 cP, 5000 cP, 6000 cP, 7000 cP, 8000 cP, 10000 cP, 20000 cP, 30000 cP, 40000 cP, 50000 cP, 60000 cP, 70000 cP, 80000 cP, 90000 cP, 95000 cP, preferably 4000 to 60000 cP, for example 4000 to 15000 cP, or 20000 cP to 60000 cP.

In one embodiment, the oligomer containing at least one ethylenically unsaturated functional group has a glass transition temperature in the range from −40 to 50° C., for example −30° C., −20° C., −10° C., 0° C., 10° C., 20° C., 30° C., or 40° C., preferably from −20 to 25° C.

The monomer can lower the viscosity of the composition. The monomer can be monofunctional or multifunctional (such as difunctional, trifunctional). In one embodiment, the monomer can be selected from the group consisting of (meth)acrylate monomer, (meth)acrylamide monomer, vinylaromatics having up to 20 carbon atoms, vinyl esters of carboxylic acids having up to 20 carbon atoms, □α,β-unsaturated carboxylic acids having 3 to 8 carbon atoms and their anhydrides, and vinyl substituted heterocycles,

In the context of the present disclosure, term “(meth)acrylate monomer” means a monomer comprises a (meth)acrylate moiety. The structure of the (meth)acrylate moiety is as follows:

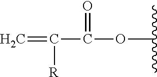

wherein R is H or methyl.

The (meth)acrylate monomer can be monofunctional or multifunctional (such as difunctional, trifunctional) (meth)acrylate monomer. Exemplary (meth)acrylate monomer can include C₁ to C₂₀ alkyl (meth)acrylate, C₁ to C₁₀ hydroxyalkyl (meth)acrylate, C₃ to C₁₀ cycloalkyl (meth)acrylate, urethane acrylate, 2-(2-ethoxy)ethyl acrylate, tetrahydrofurfuryl (meth)acrylate, 2-phenoxyethylacrylate, dicyclopentenyloxyethyl (meth)acrylate, dicyclopentadienyl (meth)acrylate, caprolactone (meth)acrylate, morpholine (meth)acrylate, ethoxylated nonyl phenol (meth)acrylate, (5-ethyl-1,3-dioxan-5-yl) methyl acrylate, phenyl (meth)acrylate, benzyl (meth)acrylate, phenethyl (meth)acrylate, dicyclopentanyl (meth)acrylate, 3,3,5-trimethylcyclohexyl (meth)acrylate and dicyclopentenyl (meth)acrylate.

Specific examples of C₁ to C₂₀ alkyl (meth)acrylate can include methyl (meth)acrylate, ethyl (meth)acrylate, isopropyl (meth)acrylate, n-propyl (meth)acrylate, n-butyl (meth)acrylate, isobutyl (meth)acrylate, tert-butyl (meth)acrylate, sec-butyl (meth)acrylate, pentyl (meth)acrylate, n-hexyl (meth)acrylate, octyl (meth)acrylate, isooctyl (meth)acrylate, 2-ethylhexyl (meth)acrylate, decyl (meth)acrylate, isodecyl (meth) methacrylate, n-lauryl (meth)acrylate, n-tridecyl (meth)acrylate, n-cetyl (meth)acrylate, n-stearyl (meth)acrylate, isomyristyl (meth)acrylate, stearyl (meth)acrylate, and isostearyl (meth)acrylate (ISTA). C₆ to C₁₈ alkyl (meth)acrylate, especially C₆ to C₁₆ alkyl (meth)acrylate or C₈ to C₁₂ alkyl (meth)acrylate is preferred.

Specific examples of C₁ to C₁₀ hydroxyalkyl (meth)acrylate, such as C₂ to C₈ hydroxyalkyl (meth)acrylate can include 2-hydroxyethyl (meth)acrylate, 2-hydroxypropyl (meth)acrylate, 3-hydroxypropyl (meth)acrylate, 3-hydroxybutyl (meth)acrylate, 4-hydroxybutyl (meth)acrylate, 6-hydroxyhexyl (meth)acrylate, or 3-hydroxy-2-ethylhexyl (meth)acrylate etc.

Specific examples of C₃ to C₁₀ cycloalkyl (meth)acrylate can include isobornyl acrylate, isobornyl methacrylate, cyclohexyl acrylate or cyclohexyl methacrylate.

Examples of the multifunctional (meth)acrylate monomer can include (meth)acrylic esters and especially acrylic esters of polyfunctional alcohols, particularly those which other than the hydroxyl groups comprise no further functional groups or, if they comprise any at all, comprise ether groups. Examples of such alcohols are, e.g., difunctional alcohols, such as ethylene glycol, propylene glycol, and their counterparts with higher degrees of condensation, for example such as diethylene glycol, triethylene glycol, dipropylene glycol, tripropylene glycol etc., 1,2-, 1,3- or 1,4-butanediol, 1,5-pentanediol, 1,6-hexanediol, 3-methyl-1,5-pentanediol, neopentyl glycol, alkoxylated phenolic compounds, such as ethoxylated and/or propoxylated bisphenols, 1,2-, 1,3- or 1,4-cyclohexanedimethanol, alcohols with a functionality of three or higher, such as glycerol, trimethylolpropane, butanetriol, trimethylolethane, pentaerythritol, ditrimethylolpropane, dipentaerythritol, sorbitol, mannitol, and the corresponding alkoxylated, especially ethoxylated and/or propoxylated, alcohols.

In the context of the present disclosure, term “(meth)acrylamide monomer” means a monomer comprises a (meth)acrylamide moiety. The structure of the (meth)acrylamide moiety is as follows: CH₂═CR¹—CO—N, wherein R 1 is hydrogen or methyl. Specific example of (meth)acrylamide monomer can include acryloylmorpholine, methacryloylmorpholine, N-(hydroxymethyl)acrylamide, N-hydroxyethyl acrylamide, N-isopropylacrylamide, N-isopropylmethacrylamide, N-tert-butylacrylamide, N,N′-methylenebisacrylamide, N(isobutoxymethyl)acrylamide, N-(butoxymethyl)acrylamide, N-[3-(dimethylamino)propyl]methacrylamide, N, N-dimethylacrylamide, N, N-diethylacrylamide, N(hydroxymethyl)methacrylamide, N-hydroxyethyl methacrylamide, N-isopropylmethacrylamide, N-isopropylmethmethacrylamide, N-tert-butylmethacrylamide, N,N′-methylenebismethacrylamide, N-(isobutoxymethyl)methacrylamide, N(butoxymethyl)methacrylamide, N-[3-(dimethylamino)propyl]methmethacrylamide, N,N-dimethylmethacrylamide and N,N-diethylmethacrylamide. The (meth)acrylamide monomer can be used alone or in combination.

Examples of vinylaromatics having up to 20 carbon atoms can include, such as styrene and C₁-C₄-alkyl substituted styrene, such as vinyltoluene, p-tert-butylstyrene and α-methyl styrene.

Examples of vinyl esters of carboxylic acids having up to 20 carbon atoms (for example 2 to 20 or 8 to 18 carbon atoms) can include vinyl laurate, vinyl stearate, vinyl propionate, and vinyl acetate.

Example of α,β-unsaturated carboxylic acids having 3 to 8 carbon atoms can be acrylic acid.

Examples of vinyl substituted heterocycles can include monovinyl substituted heterocycles, wherein the heterocycle is a 5- to 8-membered ring containing 2 to 7 carbon atoms, and 1 to 4 (preferably 1 or 2) heteroatoms selected from N, O and S, such as vinylpyridines, N-vinylpyrrolidone, N-vinylmorpholin-2-one, N-vinyl caprolactam and 1-vinylimidazole, vinyl alkyl oxazolidinone such as vinyl methyl oxazolidinone.

Preferred monomers are (meth)acrylate monomer, (meth)acrylamide monomer, vinylaromatics having up to 20 carbon atoms, and vinyl substituted heterocycles.

In a preferred embodiment, the radiation-curable reactive component (A) comprises both the oligomer and the monomer containing at least one ethylenically unsaturated functional group. The weight ratio of the oligomer to the monomer can be in the range from 10:1 to 1:10, preferably from 8:1 to 1:8, or from 5:1 to 1:5, or from 3:1 to 1:5, or from 1:1 to 1:4.

The amount of the reactive component (A) can be in the range from 2 to 97% by weight, for example 5% by weight, 10% by weight, 15% by weight, 20% by weight, 25% by weight, 30% by weight, 35% by weight, 40% by weight, 50% by weight, 60% by weight, 70% by weight, 80% by weight, 85% by weight, 90% by weight, 92% by weight, 95% by weight, 96% by weight, preferably from 5 to 96% by weight or 10 to 95% by weight, or 12 to 95% by weight, or 20 to 95% by weight, 30 to 95% by weight, 40 to 95% by weight, 50 to 95% by weight, 55 to 95% by weight, 40 to 90% by weight, 50 to 90% by weight, 55 to 90% by weight, based on the total weight of the composition. Generally, the amount of reactive component (A) depends on the 3D printing machine with different requirement on viscosity etc.

### Photoinitiator (B)

The radiation-curable liquid composition comprises at least one photoinitiator as component (B). For example, the photoinitiator component (B) may include at least one free radical photoinitiator and/or at least one ionic photoinitiator, and preferably at least one (for example one or two) free radical photoinitiator. For example, it is possible to use all photoinitiators known in the art for use in compositions for 3D-printing, e.g., it is possible to use photoinitiators that are known in the art use with SLA, DLP or PPJ (Photo polymer jetting) processes.

Exemplary photoinitiators may include benzophenone, acetophenone, chlorinated acetophenone, dialkoxyacetophenones, dialkylhydroxyacetophenones, dialkylhydroxyacetophenone esters, benzoin and derivative (such as benzoin acetate, benzoin alkyl ethers), dimethoxybenzion, dibenzylketone, benzoylcyclohexanol and other aromatic ketones, acyloxime esters, acylphosphophine oxides, acylphosphosphonates, ketosulfides, dibenzoyldisulphides, diphenyldithiocarbonate.

Specific examples of photoinitiators can include 1-hydroxycyclohexyl phenylketone, 2-methyl-1-[4-(methylthio)phenyl]-2-morpholinopropan-1-one, 2-benzyl-2-N,N-dimethylamino-1-(4-morpholinophenyl)-1-butanone, combination of 1-hydroxycyclohexyl phenyl ketone and benzophenone, 2,2-dimethoxy-2-phenyl acetophenone, bis(2,6-dimethoxybenzoyl-(2,4,4-trimethylpentyl) phosphine oxide, 2-hydroxy-2-methyl-1-phenyl-propan-1-one, bis(2,4,6-trimethyl benzoyl) phenyl phosphine oxide, 2-hydroxy-2-methyl-1-phenyl-1-propane, combination of 2,4,6-trimethylbenzoyldiphenyl-phosphine oxide, 2-hydroxy-2-methyl-1-phenyl-propan-1-one, 2,4,6-trimethylbenzoyldiphenylphosphinate and 2,4,6-trimethylbenzoyldiphenyl-phosphine oxide and also any combination thereof.

The amount of the photoinitiator (B) can be in the range from 0.1 to 10% by weight, for example 0.2% by weight, 0.5% by weight, 0.8% by weight, 1% by weight, 2% by weight, 3% by weight, 5% by weight, 8% by weight, or 10% by weight, preferably from 0.1 to 5% by weight or 0.5 to 5% by weight, based on the total weight of the composition.

Expandable Microsphere and/or Lightweight Filler (C)

According to the present invention, the radiation-curable liquid composition comprises at least one expandable microsphere and/or lightweight filler as component (C).

The expandable (usually thermo-expandable) microsphere can be broadly defined as a microsphere comprising a polymer shell and a propellant encapsulated therein. Commercial examples of such expandable microsphere include, for example, EXPANCEL DU products commercially available from Nouryon, such as EXPANCEL 031 DU, EXPANCEL 461 DU and EXPANCEL 043 DU.

The polymer shell of the expandable microsphere can be made from a polymer, especially a thermoplastic polymer.

The propellant of the expandable microsphere can be a liquid having a boiling point less than the softening temperature of the polymer shell. Expansion of the thermoplastic microspheres is typically physical by nature. When the expandable microsphere is heated up, the propellant expands, increases the intrinsic pressure, at the same time the shell softens, thus causes the microspheres' expansion. Factors such as volatility of the propellant in the microspheres, gas permeability and viscoelasticity of the polymer shell may affect the expandability of the microspheres. Usually, the expandable microsphere can be expanded by from 2 to 8 times in diameter, or from 30 to 80 times in volume. The thickness of polymer shell may decrease to 0.1 μm or even thinner after expansion.

The monomers suitable for the preparation of the polymer shell can comprise monoethylenically unsaturated C₃-C₆-mononitriles such as acrylonitrile, methacrylonitrile, α-haloacrylonitrile, aethoxyacrylonitrile, fumarc nitrile, styrene, acrylic esters or any combinations thereof. In one preferable embodiment, the polymer shell is made from poly acrylonitrile or copolymer thereof. The softening temperature (i.e., the glass transition temperature (Tg)) of the polymer shell can be in the range from 60° C. to 200° C.

The propellant of the expandable microsphere usually has a boiling point less than the softening temperature of the polymer shell. Suitable propellant can include isobutane, 2,4-dimethylbutane, 2-methylpentane, 3-methylpentane, n-hexane, cyclohexane, heptane, isooctane, or any combinations thereof.

When the expandable microsphere (such as thermo-expandable microsphere) is heated up, it starts to expand at a certain temperature. The temperature at which the expansion starts is called temperature start (Tₛₜₐᵣₜ), while the temperature at which the maximum expansion is reached is called temperature maximum (Tₘₐₓ). The Tₛₜₐᵣₜ and Tₘₐₓ can be measured by thermo mechanical analysis (TMA) of thermo expansion property. In one embodiment, the expandable microspheres can have a Tₛₜₐᵣₜ of at least 65° C., for example at least 70° C., at least 75° C., at least 80° C., at least 85° C., at least 90° C., at least 95° C., at least 100° C., at least 105° C., or at least 110° C., and a Tₘₐₓ of less than 250° C., less than 220° C., less than 200° C., less than 180° C., less than 160° C., or less than 140° C.

In one example, a lightweight filler is used as component (C). The specific examples of the lightweight filler can include hollow ceramic spheres, hollow plastic spheres, hollow glass beads, expanded plastic beads, diatomaceous earth, vermiculite, and combinations thereof.

The density of component (C) can be less than 100 kg/m³, for example in the range from 5 to 100 kg/m³ or 5 to 80 kg/m³ or 5 to 60 kg/m³ or 5 to 50 kg/m³, for example 6 kg/m³, 7 kg/m³, 8 kg/m³, 9 kg/m³, 10 kg/m³, 15 kg/m³, 20 kg/m³, 25 kg/m³, 30 kg/m³, 35 kg/m³, 40 kg/m³, 45 kg/m³, preferably from 6 to 40 kg/m³ or 7 to 35 kg/m³.

The average particle size of the expandable microspheres and the lightweight filler as component (C) can be in the range from 1 μm to 400 μm, for example, 2 μm, 3 μm, 4 μm, 5 μm, 6 μm, 7 μm, 8 μm, 9 μm, 10 μm, 15 μm, 20 μm, 25 μm, 30 μm, 40 μm, 50 μm, 60 μm, 80 μm, 100 μm, 120 μm, 150 μm, 180 μm, 200 μm, 250 μm, 300 μm, 350 μm or 400 μm, preferably from 2 μm to 300 μm, more preferably from 3 μm to 200 μm or from 4 μm to 100 μm, and most preferably from 5 μm to 50 μm.

According to the present invention, the amount of component (C) can be in the range from 0.1 to 70% by weight, for example 0.5% by weight, 1% by weight, 2% by weight, 3% by weight, 4% by weight, 5% by weight, 8% by weight, 10% by weight, 15% by weight, 20% by weight, 25% by weight, 30% by weight, 35% by weight, 40% by weight, 50% by weight, 60% by weight or 70% by weight, preferably from 1 to 60% by weight, from 2 to 50% by weight, from 2 to 40% by weight, or from 3 to 30% by weight, based on the total weight of the composition.

In one embodiment, the radiation-curable liquid composition of the present invention, comprising following components:
(A) 2 to 97% by weight of at least one radiation-curable reactive component;
(B) 0.1 to 10% by weight of at least one photoinitiator; and
(C) 0.1 to 70% by weight of at least one expandable microsphere and/or lightweight filler.

In one embodiment, the radiation-curable liquid composition of the present invention, comprising following components:
(A) 5 to 95% by weight of at least one radiation-curable reactive component;
(B) 0.1 to 5% by weight of at least one photoinitiator; and
(C) 0.1 to 70% by weight of at least one expandable microsphere and/or lightweight filler.

In one embodiment, the radiation-curable liquid composition of the present invention, comprising following components:
(A) 2 to 97% by weight of at least one radiation-curable reactive component;
(B) 0.1 to 10% by weight of at least one photoinitiator; and
(C) 1 to 60% by weight of at least one expandable microsphere and/or lightweight filler.

In one embodiment, the radiation-curable liquid composition of the present invention, comprising following components:
(A) 5 to 95% by weight of at least one radiation-curable reactive component;
(B) 0.1 to 5% by weight of at least one photoinitiator; and
(C) 1 to 60% by weight of at least one expandable microsphere and/or lightweight filler.

In one embodiment, the radiation-curable liquid composition of the present invention, comprising following components:
(A) 2 to 97% by weight of at least one radiation-curable reactive component;
(B) 0.1 to 10% by weight of at least one photoinitiator; and
(C) 2 to 50% by weight of at least one expandable microsphere and/or lightweight filler.

In one embodiment, the radiation-curable liquid composition of the present invention, comprising following components:
(A) 5 to 95% by weight of at least one radiation-curable reactive component;
(B) 0.1 to 5% by weight of at least one photoinitiator; and
(C) 2 to 50% by weight of at least one expandable microsphere and/or lightweight filler.

In one embodiment, the radiation-curable liquid composition of the present invention, comprising following components:
(A) 2 to 97% by weight of at least one radiation-curable reactive component;
(B) 0.1 to 10% by weight of at least one photoinitiator; and
(C) 2 to 40% by weight of at least one expandable microsphere and/or lightweight filler.

In one embodiment, the radiation-curable liquid composition of the present invention, comprising following components:
(A) 5 to 95% by weight of at least one radiation-curable reactive component;
(B) 0.1 to 5% by weight of at least one photoinitiator; and
(C) 2 to 40% by weight of at least one expandable microsphere and/or lightweight filler.

In one embodiment, the radiation-curable liquid composition of the present invention, comprising following components:
(A) 10 to 95% by weight of at least one radiation-curable reactive component;
(B) 0.1 to 5% by weight of at least one photoinitiator; and
(C) 2 to 40% by weight of at least one expandable microsphere and/or lightweight filler.

In one embodiment, the radiation-curable liquid composition of the present invention, comprising following components:
(A) 30 to 95% by weight of at least one radiation-curable reactive component;
(B) 0.1 to 5% by weight of at least one photoinitiator; and
(C) 2 to 40% by weight of at least one expandable microsphere and/or lightweight filler.

In one embodiment, the radiation-curable liquid composition of the present invention, comprising following components:
(A) 40 to 95% by weight of at least one radiation-curable reactive component;
(B) 0.1 to 5% by weight of at least one photoinitiator; and
(C) 2 to 40% by weight of at least one expandable microsphere and/or lightweight filler.

In one embodiment, the radiation-curable liquid composition of the present invention, comprising following components:
(A) 5 to 90% by weight of at least one radiation-curable reactive component;
(B) 0.1 to 5% by weight of at least one photoinitiator; and
(C) 2 to 40% by weight of at least one expandable microsphere and/or lightweight filler.

In one embodiment, the radiation-curable liquid composition of the present invention, comprising following components:
(A) 10 to 90% by weight of at least one radiation-curable reactive component;
(B) 0.1 to 5% by weight of at least one photoinitiator; and
(C) 2 to 40% by weight of at least one expandable microsphere and/or lightweight filler.

In one embodiment, the radiation-curable liquid composition of the present invention, comprising following components:
(A) 30 to 90% by weight of at least one radiation-curable reactive component;
(B) 0.1 to 5% by weight of at least one photoinitiator; and
(C) 2 to 40% by weight of at least one expandable microsphere and/or lightweight filler.

In one embodiment, the radiation-curable liquid composition of the present invention, comprising following components:
(A) 40 to 90% by weight of at least one radiation-curable reactive component;
(B) 0.1 to 5% by weight of at least one photoinitiator; and
(C) 2 to 40% by weight of at least one expandable microsphere and/or lightweight filler.

### Auxiliaries (D)

The composition of the present invention may further comprise one or more auxiliaries.

As auxiliaries, mention may be made by way of preferred example of surface-active substances, flame retardants, nucleating agents, lubricant wax, dyes, pigments, catalyst, UV absorbers and stabilizers, e.g. against oxidation, hydrolysis, light, heat or discoloration, inorganic and/or organic fillers, reinforcing materials and plasticizers. As hydrolysis inhibitors, preference is given to oligomeric and/or polymeric aliphatic or aromatic carbodiimides. To stabilize the material cured of the invention against aging and damaging environmental influences, stabilizers are added to system in preferred embodiments.

If the composition of the invention is exposed to thermo-oxidative damage during use, in preferred embodiments antioxidants are added. Preference is given to phenolic antioxidants. Phenolic antioxidants such as Irganox® 1010 from BASF SE are given in Plastics Additive Handbook, 5th edition, H. Zweifel, ed., Hanser Publishers, Munich, 2001, pages 98-107, page 116 and page 121.

If the composition of the invention is exposed to UV light, it is preferably additionally stabilized with a UV absorber. UV absorbers are generally known as molecules which absorb high-energy UV light and dissipate energy. Customary UV absorbers which are employed in industry belong, for example, to the group of cinnamic esters, diphenylcyan acrylates, formamidines, benzylidenemalonates, diarylbutadienes, triazines and benzotriazoles. Examples of commercial UV absorbers may be found in Plastics Additive Handbook, 5th edition, H. Zweifel, ed, Hanser Publishers, Munich, 2001, pages 116-122.

Further details regarding the abovementioned auxiliaries may be found in the specialist literature, e.g. in Plastics Additive Handbook, 5th edition, H. Zweifel, ed, Hanser Publishers, Munich, 2001.

Plasticizer can be used to lower the glass transition temperature (Tg) of the polymer. Plasticizers work by being embedded between the chains of polymers, spacing them apart (increasing the “free volume”), and thus lowering the glass transition temperature of the polymer and making it softer.

The examples of plasticizers used in the composition of the present invention can include C₃-C₁₅, preferably C₃-C₁₀ polycarboxylic acids and their esters with linear or branched C₂-C₃₀, preferably C₄-C₂₀, more preferably C₄-C₁₂ aliphatic alcohols, benzoates, epoxidized vegetable oils, sulfonamides, organophosphates, glycols and its derivatives, polymeric plasticizers, polyethers, polybutene. In some preferred embodiments, the plasticizers suitable for the present invention include but are not limited to C₃-C₁₅, preferably C₃-C₁₀ aromatic dicarboxylic or tricarboxylic acids and their esters with linear or branched C₂-C₃₀, preferably C₄-C₂₀, more preferably C₄-C₁₂ aliphatic alcohols, such as phthalic acid and phthalate-based plasticizers; C₃-C₁₅, preferably C₃-C₁₀ aliphatic dicarboxylic or tricarboxylic acids and their esters with linear or branched C₂-C₃₀, preferably C₄-C₂₀, more preferably C₄-C₁₂ aliphatic alcohols, such as adipic acid and adipates, sebacic acid and sebacate, maleic acid and maleates, azelaic acid and azelates; cyclic aliphatic polycarboxylic acids and their esters with linear or branched C₂-C₃₀, preferably C₄-C₂₀, more preferably C₄-C₁₂ aliphatic alcohols, such as cyclohexane dicarboxylic acid and its ester.

Preferred plasticizers are sebacic acid, sebacates, adipic acid, adipates, glutaric acid, glutarates, phthalic acid, phthalates (for example with C₈ alcohols), azelaic acid, azelates, maleic acid, maleate, citric acid and its derivatives, see for example WO 2010/125009, incorporated herein by reference. The plasticizers may be used in combination or individually.

One specific class of preferred plasticizers is phthalate-based plasticizers, such as phthalate esters of C₈ alcohols, which are advantageous for resistance to water and oils. Some preferred phthalate plasticizers are bis(2-ethylhexyl) phthalate (DEHP), preferably used in construction materials and medical devices, diisononyl phthalate (DINP), preferably used in garden hoses, shoes, toys, and building materials, di-n-butyl phthalate (DNBP, DBP), butyl benzyl phthalate (BBZP), preferably used for food conveyor belts, artificial leather, and foams, diisodecyl phthalate (DIDP), preferably used for insulation of wires and cables, car undercoating, shoes, carpets, pool liners, di-n-octyl phthalate (DOP or DNOP), preferably used in flooring materials, carpets, notebook covers, and high explosives, diisooctyl phthalate (DIOP), diethyl phthalate (DEP), and diisobutyl phthalate (DIBP), di-n-hexyl phthalate, preferably used in flooring materials, tool handles, and automobile parts.

Another preferred class of plasticizers can be selected from the group consisting of adipates, sebacates and maleates, such as bis(2-ethylhexyl)adipate (DEHA), dimethyl adipate (DMAD), monomethyl adipate (MMAD), dioctyl adipate (DOA), diisodecyl adipate (DINA), dibutyl sebacate (DBS), dibutyl maleate (DBM), and diisobutyl maleate (DIBM). Adipate-based plasticizers are preferred, preferably used for low-temperature application and high resistance to ultraviolet light.

Other preferred plasticizers are selected from the group consisting of benzoates; epoxidized vegetable oils; sulfonamides, such as N-ethyl toluene sulfonamide (o/p ETSA), ortho- and para-isomers, N-(2-hydroxypropyl) benzene sulfonamide (HP BSA), N-(n-butyl) benzene sulfonamide (BBSA-NBBS); organophosphates, such as tricresyl phosphate (TCP), tributyl phosphate (TBP); glycols/polyether and their derivatives, such as triethylene glycol dihexanoate (3G6, 3GH), tetraethylene glycol diheptanoate (4G7); polymeric plasticizer, such as epoxidized oils of high molecular weight and polyester plasticizers, polybutene and polyisobutylene.

Polyester plasticizers are generally prepared by esterification of polyhydric alcohols, as for example 1,2-ethanediol, 1,2-propanediol, 1,3-propanediol, 1,3-butanediol, 1,4-butanediol, 1,5-pentanediol, or 1,6-hexanediol, with a polycarboxylic acid, such as succinic acid, glutaric acid, adipic acid, pimelic acid, suberic acid, sebacic acid, or azelaic acid. Optionally, it is possible for terminal alcohol groups (in the case of synthesis with alcohol excess) to be capped with monocarboxylic acids, such as acetic acid, or for terminal acid groups (in the case of synthesis with acid excess) to be capped with monohydric alcohols, such as 2-ethylhexanol, isononanol, 2-propylheptanol or isodecanol. Examples of suitable commercial available polyester plasticizers are those available from BASF SE, under the brand name Palamoll® 638 (polyester plasticizer based on adipic acid, 1,2-propanediol and n-octanol), Palamoll® 652 (polyester plasticizer based on adipic acid, 1,2-propanediol, neopentyl glycol and isononanol), Palamoll® 654 (polyester plasticizer based on adipic acid, 1,4-butanediol, neopentyl glycol and isononanol) or Palamoll® 656 (polyester plasticizer based on adipic acid, 1,4-butanediol, neopentyl glycol and isononanol).

In alternative embodiment, the plasticizers can be biodegradable plasticizers, preferably selected from acetylated monoglycerides, preferably for the use as food additives, alkyl citrates, also preferably used in food packaging, medical products, cosmetics and children toys, such as triethyl citrate (TEC), acetyl triethyl citrate (ATEC), tributyl citrate (TBC), acetyl tributyl citrate (ATBC), especially compatible with PVC and vinyl chloride copolymers, trioctyl citrate (TOC), preferably used for gums and controlled release medicines, acetyl trioctyl citrate (ATOC), preferably used for printing ink, trihexyl citrate (THC), preferably used for controlled release medicines, acetyl trihexyl citrate (ATHC), butyryl trihexyl citrate, also referred to as BTHC, trihexyl obutyryl citrate, trimethyl citrate (TMC), and also alkyl sulphonic acid phenyl ester (ASE).

In a preferred embodiment, the plasticizers can be selected from the group consisting of cyclohexane dicarboxylic acid and its esters, preferably esters of 1,2-cyclohexane dicarboxylic acid, more preferably 1,2-cyclohexane dicarboxylic acid diisononyl ester (such as Hexamoll® DINCH from BASF SE).

According to the present invention, the auxiliary can be present in an amount of from 0 to 50% by weight, from 0.01 to 50% by weight, for example from 0.5 to 30% by weight, based on the total weight of the composition.

### Preparation of the Composition

A further aspect of this disclosure relates to a process of preparing the radiation-curable liquid composition of the present invention, comprising mixing the components of the composition.

According to an embodiment of the invention, the mixing can be carried out at room temperature with stirring. There is no particular restriction on the time of mixing and rate of stirring, as long as all components are uniformly mixed together. In a specific embodiment, the mixing can be carried out at 1000 to 3000 RPM, preferably 1500 to 2500 RPM for 5 to 60 min, more preferably 6 to 30 min.

### 3D-Printed Object and Preparation Thereof

One aspect of the present disclosure relates to a process of forming 3D-printed object, comprising using the radiation-curable liquid composition of the present invention or the radiation-curable liquid composition obtained by the process of the present invention.

The radiation-curable liquid composition can be cured by actinic ray that has sufficient energy to initiate a polymerization or cross-linking reaction. The actinic ray can include but is not limited to α-rays, γ-rays, ultraviolet radiation (UV radiation), visible light, and electron beams, wherein UV radiation and electron beams, especially, UV radiation is preferred.

In a specific embodiment, the wavelength of the radiation light can be in the range from 360 to 420 nm, for example 365, 385, 395, 405, 420 nm. The energy of radiation can be in the range from 0.5 to 50 mw/cm², for example 1 mw/cm², 2 mw/cm², 3 mw/cm², 4 mw/cm², 5 mw/cm², 8 mw/cm², 10 mw/cm², 20 mw/cm², 30 mw/cm², 40 mw/cm², or 50 mw/cm², preferably from 1 to 15 mw/cm² or from 1 to 8 mw/cm². The radiation time can be in the range from 0.5 to 10 s, preferably from 0.6 to 6 s.

The process of forming 3D-printed objects can include stereolithography (SLA), digital light processing (DLP) or photopolymer jetting (PPJ) and other technique known by the skilled in the art. Preferably, the production of cured 3D objects of complex shape is performed for instance by means of stereolithography, which has been known for a number of years. In this technique, the desired shaped article is built up from a radiation-curable composition with the aid of a recurring, alternating sequence of two steps (1) and (2). In step (1), a layer of the radiation-curable composition, one boundary of which is the surface of the composition, is cured with the aid of appropriate imaging radiation, preferably imaging radiation from a computer-controlled scanning laser beam, within a surface region which corresponds to the desired cross-sectional area of the shaped article to be formed, and in step (2) the cured layer is covered with a new layer of the radiation-curable composition, and the sequence of steps (1) and (2) is often repeated until the desired shape is finished.

In one embodiment, the process comprises the steps of:
(i) forming a layer of the radiation-curable liquid composition;
(ii) applying radiation to cure at least a portion of the layer of the radiation-curable liquid composition to form a cured layer;
(iii) introducing a new layer of the radiation-curable liquid composition onto the cured layer;
(iv) applying radiation to the new layer of the radiation-curable liquid composition to form a new cured layer; and
(v) repeating steps (iii) and (iv) until the 3D object is manufactured.

According to the invention, the curing time in step (ii) or (iv) is from 0.5 to 10 s, preferably from 0.6 to 6 s. There is no specific restriction on temperature during curing. Specifically, the temperature during curing depends on material and 3D printer used.

In one embodiment, the process further comprises a step of post-curing the 3D object obtained in step (v) as a whole to form a final 3D object. The post-curing can be carried out by UV radiation, thermal treatment or combination thereof.

Usually, the temperature in the thermal treatment is in the range from 90 to 160° C., preferably 100 to 140° C. According to the invention, the post-curing time can be in the range from 30 min to 500 min, for example 60 min, 120 min, 180 min, 250 min, 300 min, 400 min, preferably from 60 min to 250 min.

A further aspect of the present disclosure relates to a 3D-printed object formed from the radiation-curable liquid composition of the present invention or obtained by the process of the present invention.

The 3D-printed objects can include sole, outerwear, cloth, footwear, toy, mat, tire, hose, gloves and seals.

The 3D-printed object of the present invention shows excellent elasticity (energy return) property. In a preferred embodiment, the energy return of 3D-printed object can be increased by 5 to 30%, for example 5%, 6%, 7%, 8%, 9%, 10%, 12%, 15%, 18%, 20%, 22%, 25%, 28% or 30%, preferably 7 to 25%, comparing with a 3D-printed object formed from the otherwise identical radiation-curable liquid composition only without component (C).

According to the present invention, energy return can be determined according to ISO 527-5:2009. The analyser for testing energy return can be Stable Micro Systems Texture Analyser (TA-HD plus), wherein the parameters used include: Pre-test Speed: 60.0 mm/min; Test Speed (load): 100.2 mm/min; Post-test Speed (unload): 100.2 mm/min; Strain: 50%; Cycles: 6.

The 3D-printed object of the present invention also shows low density. In a preferred embodiment, the density of the 3D-printed object can be less than 1.1 g/cm³, less than 1.09 g/cm³, less than 1.08 g/cm³, less than 1.07 g/cm³, less than 1.06 g/cm³, less than 1.05 g/cm³, less than 1.02 g/cm³, or even less than 1 g/cm³.

### EXAMPLES

### Materials and Abbreviation

### Component (A):

Bomar® BR-744SD: a difunctional, aliphatic polyester urethane acrylate from Dymax, its viscosity at 60° C. is 7000 cP; Tg of BR-744SD is −8° C.;
Bomar® BR-744BT: a difunctional, aliphatic polyester urethane acrylate from Dymax, its viscosity at 60° C. is 46000 cP; Tg of BR-744BT is 9° C.;
iso-Decyl Acrylate (IDA);
Vinyl methyl oxazolidinone (VMOX) from BASF.

### Component (B)

Photoinitiator: 2,4,6-trimethylbenzoyldiphenylphosphine oxide (TPO) from IGM.

### Component (C)

Expandable microsphere: Expancel 031 DU 40, Expancel 461 DU 20, Expancel 043 DU 80 from Nouryon. The parameters of these expandable microspheres were as follows:

| | Particle size | Temperature | Temperature | Density |
|---|---|---|---|---|
| Expancel | (μm) | start (° C.) | Maximum (° C.) | (kg/m³) |
| 031 DU 40 | 10-16 | 80-95 | 120-135 | ≤12 |
| 043 DU 80 | 16-24 | 95-115 | 147-167 | ≤10 |
| 461 DU 20 | 6-9 | 100-106 | 143-151 | ≤30 |

### Auxiliary (D)

Plasticizer: DINCH:1,2-cyclohexane dicarboxylic acid diisononyl ester i.e. Hexamoll® DINCH® from BASF.

### Methods

### (1) Tensile Test (Including Tensile Strength and Elongation at Break)

Tensile strength and Elongation at break were determined according to ISO 527-5:2009 with Zwick, Z050 Tensile equipment, wherein the parameters used include: Start position: 50 mm; Pre-load: 0.02 MPa; Test speed: 50 mm/min.

(2) Hardness Hardness was determined in accordance with ASTM D2240-15 with ASKER DUROMETER (TYPE A).

### (3) Energy Return (Cyclic Tensile Test)

Energy return was determined according to ISO 527-5:2009 with Stable Micro Systems Texture Analyser (TA-HD plus), wherein the parameters used include: Pre-test Speed: 60.0 mm/min; Test Speed (load): 100.2 mm/min; Post-test Speed (unload): 100.2 mm/min; Strain: 50%; Cycles: 6.

The energy return was calculated by the area under loading curve and unloading curve: Energy Return=(Area Under Unloading Curve)/(Area Under Loading Curve)*100%

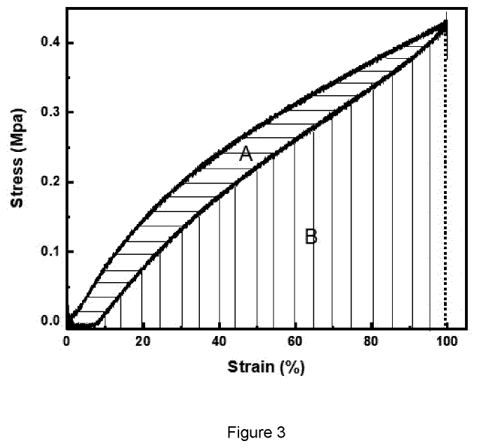

In FIG. 3, Energy Return=B/(A+B)*100%, wherein B represents Area Under Unloading Curve, and A+B represents Area Under Loading Curve.

### (4) Density

Density was determined according to ASTM-D-792.

### Examples 1, 1a, 2, 2a, 2b, 2c, 2d, 3a, 3b

### 1. Preparation of the Radiation-Curable Compositions

The radiation-curable compositions in examples 1, 1a, 2, 2a, 2b, 2c, 2d, 3a, 3b were prepared by adding all components in amounts as shown in table 1 into a plastic vial and mixing by speed-mixer at 2000 RPM for 10 minutes at 25° C. to obtain the radiation-curable liquid compositions.

TABLE 1
the amount of each component

| Example | 1 | 1a | 2 | 2a | 2b | 2c | 2d | 3a | 3b |
|---|---|---|---|---|---|---|---|---|---|
| Expancel 031 | | 5 | | 5 | 10 | 20 | 30 | | |
| DU 40(g) | | | | | | | | | |
| Expancel 461 | | | | | | | | 5 | |
| DU 20(g) | | | | | | | | | |
| Expancel 043 | | | | | | | | | 5 |
| DU 80(g) | | | | | | | | | |
| BR-744BT (g) | 20 | 20 | | | | | | | |
| BR-744SD (g) | | | 30 | 30 | 30 | 30 | 30 | 30 | 30 |
| DINCH (g) | 20 | 20 | | | | | | | |
| IDA (g) | 10 | 10 | 35 | 35 | 35 | 35 | 35 | 35 | 35 |
| VMOX (g) | 30 | 30 | 35 | 35 | 35 | 35 | 35 | 35 | 35 |
| TPO (g) | 2 | 2 | 2 | 2 | 2 | 2 | 2 | 2 | 2 |

### 2. Test of the Printing Samples

### 2.1 Preparation of the Cured Sample

150 g of compositions prepared according to the procedure in examples 1, 1a, 2, 2a, 2b, 2c, 2d, 3a, 3b were printed layer by layer using Miicraft 1503D (Pr 1) or Moonray printer (Pr 2) at 25° C. under specific printing parameters as shown in Table 2. After printing process, the printed parts were post-treated in NextDent™ LC-3D print Box under UV light for 60 min (wherein 12 lamps with a power of 18 W (6 color numbers 71 & 6 color numbers 78) were used) and thermal treated in oven at 130° C. for 60 min.

TABLE 2
Printing parameters

| Example | 1 | 1a | 2 | 2a | 2b | 2c | 2d | 3a | 3b |
|---|---|---|---|---|---|---|---|---|---|
| 3D printer | Pr 1 | Pr 1 | Pr 2 | Pr 2 | Pr 2 | Pr 2 | Pr 2 | Pr 2 | Pr 2 |
| Wavelength of | 405 | 405 | 405 | 405 | 405 | 405 | 405 | 405 | 405 |
| UV light (nm) | | | | | | | | | |
| UV energy | 4.75 | 4.75 | 1.68 | 1.68 | 1.68 | 1.68 | 1.68 | 1.68 | 1.68 |
| (mW/cm²) | | | | | | | | | |
| Base curing | 2 | 2 | 3 | 3 | 3 | 3 | 3 | 3 | 3 |
| Base layer | 1 | 1 | 1 | 1 | 1 | 1 | 1 | 1 | 1 |
| Curing time (s) | 0.82 | 0.82 | 3 | 3 | 3 | 3 | 3 | 3 | 3 |

### 2.2 Preparation of the Test Bar

The cured samples obtained from above step 2.1 were each cut to be a Strip-shaped test bar, having a dimension of 40 mm×4 mm×2 mm.

### 2.3 Test Results

The test bars were tested as described above, respectively. The test results were shown in the following Table 3.

TABLE 3
test results of the cured compositions

| Example | 1 | 1a | 2 | 2a | 2b | 2c | 2d | 3a | 3b |
|---|---|---|---|---|---|---|---|---|---|
| Tensile strength | 5.5 | 5.3 | 6.3 | 4.1 | 4.5 | 3.7 | 2.9 | 4.4 | 4.1 |
| (MPa) | | | | | | | | | |
| Elongation | 93 | 100 | 148 | 137 | 137 | 102 | 44 | 141 | 135 |
| at break (%) | | | | | | | | | |
| Hardness | 87 | 86 | 68 | 74 | 72 | 75 | 77 | 68 | 72 |
| (shore A) | | | | | | | | | |
| Energy | 46.5 | 53.7 | 43.7 | 52.7 | 57.0 | 55.0 | 51.0 | 61.2 | 56.4 |
| return (%) | | | | | | | | | |
| Density | 1.092 | 1.086 | 1.101 | 1.082 | 1.057 | 0.995 | 0.787 | 1.073 | 1.041 |
| (g/cm³) | | | | | | | | | |

Comparing the properties of the cured samples of examples 1 and 1a, the introduction of 5 g expandable microsphere (Expancel 031) in example 1a significantly increased the energy return and lowered the density of the cured sample.

Comparing properties of the cured samples of examples 2, 2a, 2b, 2c and 2d, the density decreased with increasing amount of Expancel 031, and the energy return of all cured samples comprising Expancel 031 were higher than that of the cured sample without Expancel 031 (i.e. example 2). The density of cured sample of example 2d was only 0.787 g/cm³ which reduced by 28.5% comparing with cured sample without expandable microspheres. The expandable microspheres introduced in examples 3a and 3b were different from the expandable microsphere in example 2, the cured samples of examples 3a and 3b all showed higher energy return and good mechanical properties.

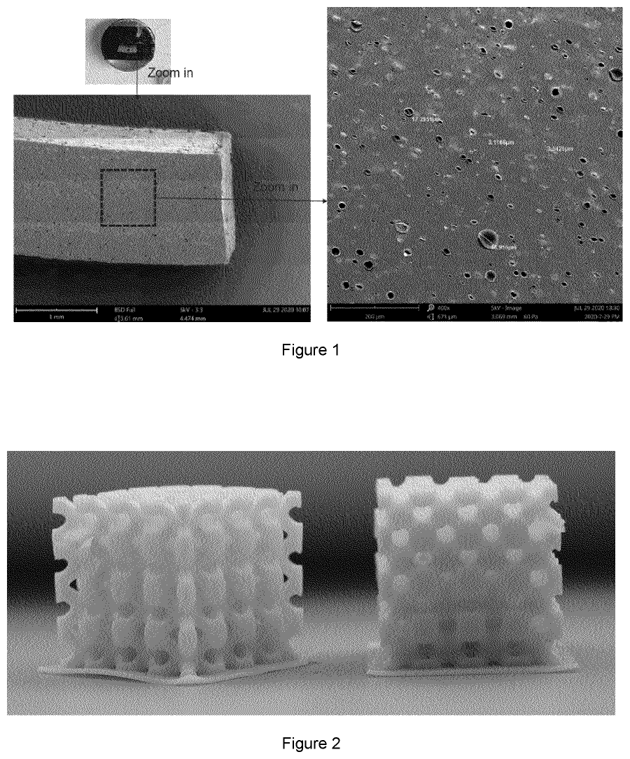

FIG. 1 shows the morphology of cured composition of example 2b which exhibited foamed structure. The 3D-printed objects obtained by printing the composition of example 2b was shown in FIG. 2.

1.-15. (canceled)

16. A radiation-curable liquid composition, comprising following components:
(A) at least one radiation-curable reactive component;
(B) at least one photoinitiator; and
(C) at least one expandable microsphere and/or lightweight filler.

17. The radiation-curable liquid composition according to claim 16, wherein the reactive component (A) comprises at least one oligomer and/or monomer containing at least one ethylenically unsaturated functional group.

18. The radiation-curable liquid composition according to claim 16, wherein the functionality of the reactive component (A) is in the range from 1 to 12.

19. The radiation-curable liquid composition according to claim 17, wherein the oligomer containing at least one ethylenically unsaturated functional group is selected from the following classes: urethane, polyether, polyester, polycarbonate, polyestercarbonate, epoxy, silicone or any combination thereof.

20. The radiation-curable liquid composition according to claim 17, wherein the monomer containing at least one ethylenically unsaturated functional group is monofunctional or multifunctional.

21. The radiation-curable liquid composition according to claim 16, wherein the amount of the reactive component (A) is in the range from 2 to 97% by weight, based on the total weight of the composition.

22. The radiation-curable liquid composition according to claim 16, wherein the amount of the photoinitiator (B) is in the range from 0.1 to 10% by weight, based on the total weight of the composition.

23. The radiation-curable liquid composition according to claim 16, wherein the amount of component (C) is in the range from 0.1 to 70% by weight, based on the total weight of the composition.

24. The radiation-curable liquid composition according to claim 16, wherein the composition further comprises at least one auxiliary as component (D) in an amount of 0 to 50% by weight or 5 to 40% by weight, based the total weight of the composition.

25. A process of forming 3D-printed object, comprising using the radiation-curable liquid composition according to claim 16.

26. The process according to claim 25, wherein the process comprises the steps of:
(i) forming a layer of the radiation-curable liquid composition;
(ii) applying radiation to cure at least a portion of the layer of the radiation-curable liquid composition to form a cured layer;
(iii) introducing a new layer of the radiation-curable liquid composition onto the cured layer;
(iv) applying radiation to the new layer of the radiation-curable liquid composition to form a new cured layer; and
(v) repeating steps (iii) and (iv) until the 3D object is manufactured.

27. The process according to claim 26, wherein the process further comprises a step of postcuring the 3D object obtained in step (v) as a whole to form a final 3D object.

28. A 3D-printed object formed from the radiation-curable liquid composition according to claim 16.

29. A 3D-printed object obtained by the process according to claim 25.

30. The 3D-printed object according to claim 28, wherein the 3D-printed objects include sole, outerwear, cloth, footwear, toy, mat, tire, hose, gloves and seals.

31. The 3D-printed object according to claim 28, wherein the energy return of said 3D-printed object increased by 5 to 30%, comparing with a 3D-printed object formed from the otherwise identical radiation-curable liquid composition only without component (C).
